(19) United States
(12) Patent Application Publication
(10) Pub. No.: US 2016/0094849 A1
(43) Pub. Date: Mar. 31, 2016

(54) THERMAL THROTTLING OF WiDi VIDEO STREAM RESOLUTION

(71) Applicant: Intel Corporation, Santa Clara, CA (US)

(72) Inventor: JEREMY BURR, Portland, OR (US)

(73) Assignee: Intel Corporation, Santa Clara, CA (US)

(21) Appl. No.: 14/499,106

(22) Filed: Sep. 27, 2014

(51) Int. Cl. H04N 19/164; H04N 19/136; G06F 1/32

(52) U.S. Cl. CPC H04N 19/164; G06F 1/3203; H04N 19/136

(57) ABSTRACT

Methods and apparatus relating to thermal throttling of WiDi (Wireless Display) video stream resolution are described. In an embodiment, logic generates one or more signals to cause a processor to a change the resolution and/or frame rate of a video stream in response to input from one or more sensors and one or more values. The one or more signals can also cause wireless display logic to modify a compression level of the video stream received from the processor prior to transmission of a compressed version of the video stream to a display device. Other embodiments are also disclosed and claimed.

### FIELD

The present disclosure generally relates to the field of electronics. More particularly, an embodiment relates to thermal throttling of WiDi (Wireless Display) video stream resolution.

### BACKGROUND

To control power consumption, some processors are capable of operating at several different frequencies. For example, if a system is to reduce its power consumption (e.g., during idle times), a processor may be operated at a lower frequency. Alternatively, to improve performance (e.g., during complex computations), the processor may be operated at a higher frequency. Furthermore, some processors may be used to perform graphics computations (also referred to as graphics processors). As video streaming applications become more popular, the usage of graphics processors has more impact on overall system performance, e.g., resulting in increased power consumption, performance reduction, and/or decreased battery life.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1 and 3-5 illustrate block diagrams of embodiments of computing systems, which may be utilized to implement various embodiments discussed herein.

FIG. 2 illustrates a flow diagram of a method to provide thermal throttling of WiDi video/image stream resolution, in accordance with an embodiment.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware, software, firmware, or some combination thereof.

Small form factor devices, such as mobile phones and phablets, have limited thermal headroom/budget. Performing CPU/GPU (Central Processing Unit/Graphics Processing Unit) computations adds heat to the system. Existing mechanisms to limit heat production limit overall system-level performance with little regard for the substance of what they are limiting; therefore, overall system responsiveness may be limited when the heat output corresponds to the system's thermal limits. Furthermore, existing mechanisms for limiting WiDi (Wireless Display) throughput relate almost entirely to link quality because the thermal limits of the system are not comprehended within these feedback mechanisms. Hence, a WiDi link is optimized for pixel throughput, without regard for utilizing system-level power as a priority. Existing WiDi optimizations reflect link management (bits per second (bps) throttling) versus thermal management. These existing optimizations are implemented as higher video compression to reduce the bandwidth (BW) of the transmitted video stream. Some exceptions to this exist, such as Panel Self-Refresh (PSR) implementations that have been copied over from HDMI/DP (High Definition Multimedia Interface/Display Port) technologies into WiDi specification, but none exist that relate to this problem. The is currently no way for the link BW and video quality metrics to impact the steady state thermal budget of the platform, and specifically where the thermal budget is extremely constrained. Some combination of link management and thermal management is required.

To this end, some embodiments provide thermal throttling of graphics logic (e.g., WiDi (Wireless Display)) video/image streaming resolution, frame rate, and/or compression levels. In an embodiment, the CPU (or more generally a general-purpose processor) processing level/resolution of a video stream (or image(s)) and/or GPU processing level/resolution of a video stream (or image(s)) is reduced when the computing system/platform (that includes the CPU and/or GPU) experiences thermal constraints. For example, when the system/platform is thermally constrained, video/image processing is performed at a lower pixel resolution, and potentially at a lower compression level. By contrast, in existing implementations, when thermal budget is constrained, all CPU/GPU activities are throttled.

As discussed herein, graphics logic (also referred to herein as “GFX”) may include a GPU (Graphics Processing Unit) or other types of logic that perform computation(s) relating to graphics task(s), such as operation(s) that manipulate an image, frame, scene, etc., e.g., as will be further discussed herein. Graphics logic may include logic to perform WiDi related operations. Generally, WiDi technology (developed by Intel® Corporation) enables a computing device to stream music, movies, images, videos and applications wirelessly from to a compatible high-definition television (e.g., either directly or through an adapter).

While some embodiments are discussed with reference to graphics logic, embodiments are not limited to graphics related logic and may be also applied to other types of non-graphic (e.g., general purpose) logic also. Moreover, various embodiments may be performed for any type of computing device such as a desktop computer, a mobile computer (such as a smartphone, tablet, UMPC (Ultra-Mobile Personal Computer), laptop computer, Ultrabook™ computing device, wearable device (such as a smart watch, smart glasses, etc.)), a work station, etc., which may be embodied on a SOC (System On Chip) platform in an embodiment.

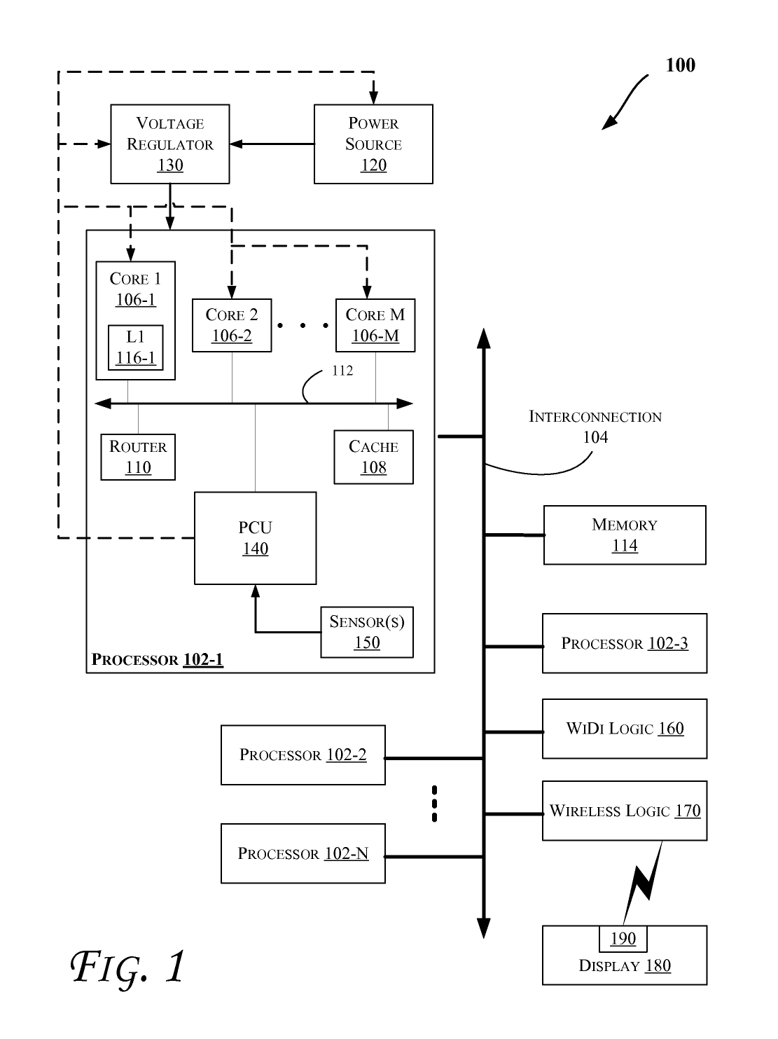

More specifically, some embodiments may be applied in computing systems that include one or more processors (e.g., with one or more processor cores), such as those discussed with reference to FIGS. 1-5, including for example mobile computing devices such as a smartphone, tablet, UMPC (Ultra-Mobile Personal Computer), laptop computer, Ultrabook™ computing device, smart watch, smart glasses, etc. More particularly, FIG. 1 illustrates a block diagram of a computing system 100, according to an embodiment. The system 100 may include one or more processors 102-1 through 102-N (generally referred to herein as “processors 102” or “processor 102”). The processors 102 may be general-purpose CPUs and/or GPUs in various embodiments. The processors 102 may communicate via an interconnection or bus 104. Each processor may include various components some of which are only discussed with reference to processor 102-1 for clarity. Accordingly, each of the remaining processors 102-2 through 102-N may include the same or similar components discussed with reference to the processor 102-1.

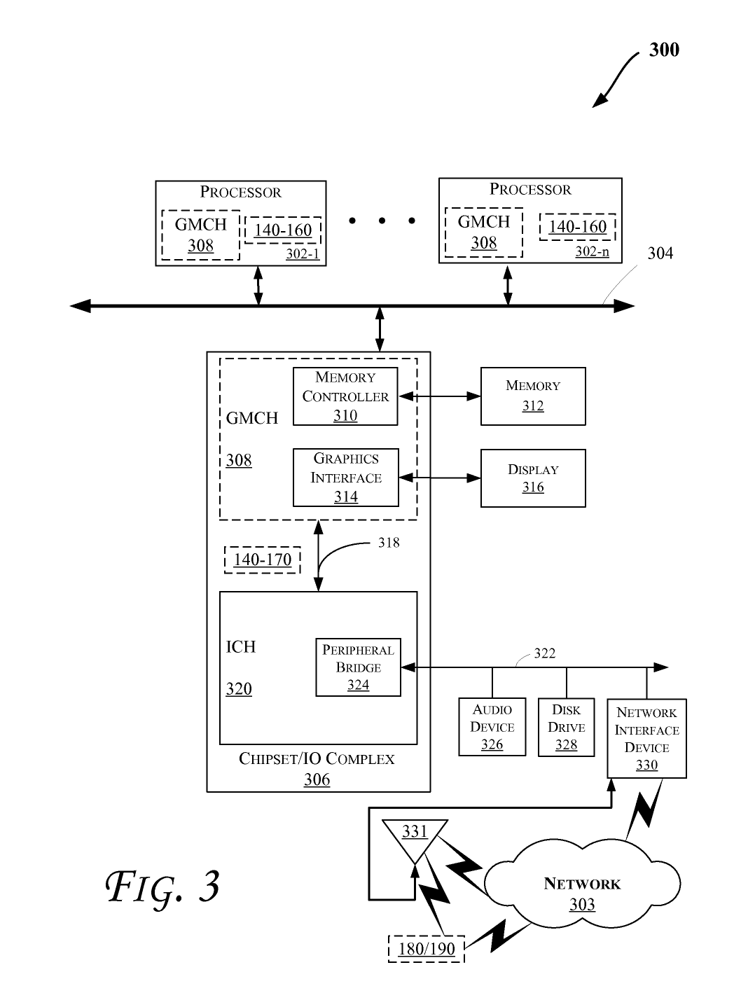

In an embodiment, the processor 102-1 may include one or more processor cores 106-1 through 106-M (referred to herein as “cores 106,” or “core 106”), a cache 108, and/or a router 110. The processor cores 106 may be implemented on a single integrated circuit (IC) chip. Moreover, the chip may include one or more shared and/or private caches (such as cache 108), buses or interconnections (such as a bus or interconnection 112), graphics and/or memory controllers (such as those discussed with reference to FIGS. 3-5), or other components.

In one embodiment, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The cache 108 may store data (e.g., including instructions) that are utilized by one or more components of the processor 102-1, such as the cores 106. For example, the cache 108 may locally cache data stored in a memory 114 for faster access by the components of the processor 102 (e.g., faster access by cores 106). As shown in FIG. 1, the memory 114 may communicate with the processors 102 via the interconnection 104. In an embodiment, the cache 108 (that may be shared) may be a mid-level cache (MLC), a last level cache (LLC), etc. Also, each of the cores 106 may include a level 1 (L1) cache (116-1) (generally referred to herein as “L1 cache 116”) or other levels of cache such as a level 2 (L2) cache. Moreover, various components of the processor 102-1 may communicate with the cache 108 directly, through a bus (e.g., the bus 112), and/or a memory controller or hub.

The system 100 may also include a power source 120 (e.g., a direct current (DC) power source or an alternating current (AC) power source) to provide power to one or more components of the system 100. In some embodiments, the power source 120 may include one or more battery packs and/or power supplies. The power source 120 may be coupled to components of system 100 through a voltage regulator (VR) 130 (which may be a single or multiple phase VR). In an embodiment, the VR 130 may be a FIVR (Fully Integrated Voltage Regulator). Moreover, even though FIG. 1 illustrates one power source 120 and one voltage regulator 130, additional power sources and/or voltage regulators may be utilized. For example, each of the processors 102 may have corresponding voltage regulator(s) and/or power source(s). Also, the voltage regulator(s) 130 may be coupled to the processor 102 via a single power plane (e.g., supplying power to all the cores 106) or multiple power planes (e.g., where each power plane may supply power to a different core or group of cores). The power source may be capable of driving variable voltage or have different power drive configurations.

Additionally, while FIG. 1 illustrates the power source 120 and the voltage regulator 130 as separate components, the power source 120 and the voltage regulator 130 may be integrated and/or incorporated into other components of system 100. For example, all or portions of the VR 130 may be incorporated into the power source 120 and/or processor 102. Furthermore, as shown in FIG. 1, the power source 120 and/or the voltage regulator 130 may communicate with the power control logic 140 and report their power specification.

As shown in FIG. 1, the processor 102 may further include a Power Control Unit (PCU) logic 140 to control supply of power to one or more components of the processor 102 (e.g., cores 106). Logic 140 may have access to one or more storage devices discussed herein (such as cache 108, L1 cache 116, memory 114, register(s), or another memory in system 100) to store information relating to operations of the PCU logic 140 such as information communicated with various components of system 100 as discussed here.

As shown, the logic 140 may be coupled to the VR 130 and/or other components of system 100 such as the cores 106 and/or the power source 120. For example, the PCU logic 140 may be coupled to receive information (e.g., in the form of one or more bits or signals) to indicate status of one or more sensors 150 (where the sensor(s) 150 may be located proximate to components of system 100 (or other computing systems discussed herein such as those discussed with reference to other figures including FIGS. 3-5, for example), including the cores 106, interconnections 104 or 112, etc., to sense variations in various factors affecting power/thermal behavior of the system, such as temperature, operating frequency, operating voltage, operating current, dynamic capacitance, power consumption, inter-core communication activity, etc.).

The logic 140 may in turn instruct the VR 130, power source 120, and/or individual components of system 100 (such as the cores 106) to modify their operations. For example, logic 140 may indicate to the VR 130 and/or power source 120 to adjust their output. In some embodiments, logic 140 may request the cores 106 to modify their operating frequency, power consumption, dynamic capacitance, operating current, etc. Also, even though components 140 and 150 are shown to be included in processor 102-1, these components may be provided elsewhere in the system 100. For example, power control logic 140 may be provided in the VR 130, in the power source 120, directly coupled to the interconnection 104, within one or more (or alternatively all) of the processors 102, etc. Also, even though cores 106 are shown to be processor cores, these can be other computational element such as graphics cores, special function devices, etc.

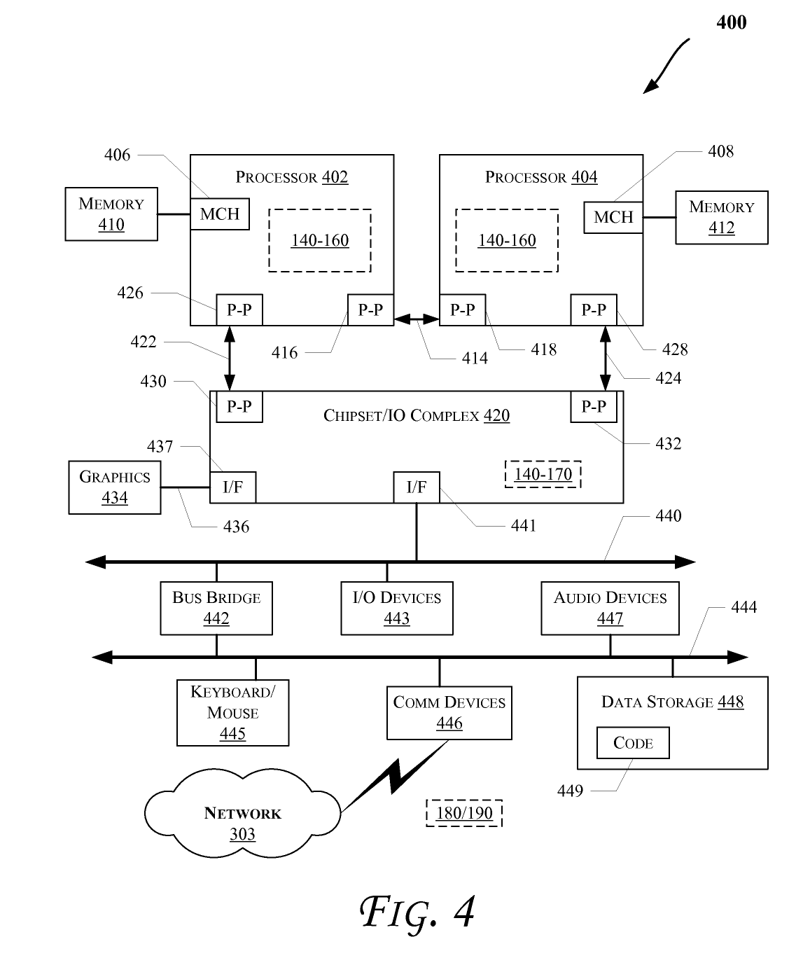

Furthermore, sensor(s) 150 may detect system configuration changes (e.g., detect whether a device is docked or undocked). Hence, sensor(s) 150 may be provided in other locations other than that shown in FIG. 1. For example, sensor(s) 150 may provide system configuration information to WiDi/graphics logic 160, which may in turn cause modification to video/image resolution and/or frame rate to be displayed on a display device 180, e.g., via wireless logic 170 which is wirelessly coupled to wireless logic 190 that is in turn coupled to display 180. Hence, system 100 can additionally include an antenna (such antenna 331 of FIG. 3) to facilitate wireless communication between the wireless logic 170 and wireless logic 190 e.g., via an Institute of Electrical and Electronics Engineers (IEEE) 802.11 interface (including IEEE 802.11a/b/g/n, etc.), cellular interface, 3G, 5G, LPE, etc.). Further, wireless logic 170 and 190 may also communicate via a network (such as network 303 discussed with reference to FIGS. 3-4). Also, even though logic 160 and 170 are illustrated to communicate via interconnect 104 in FIG. 1, these modules can also communicate directly via point-to-point link (not shown) in an embodiment.

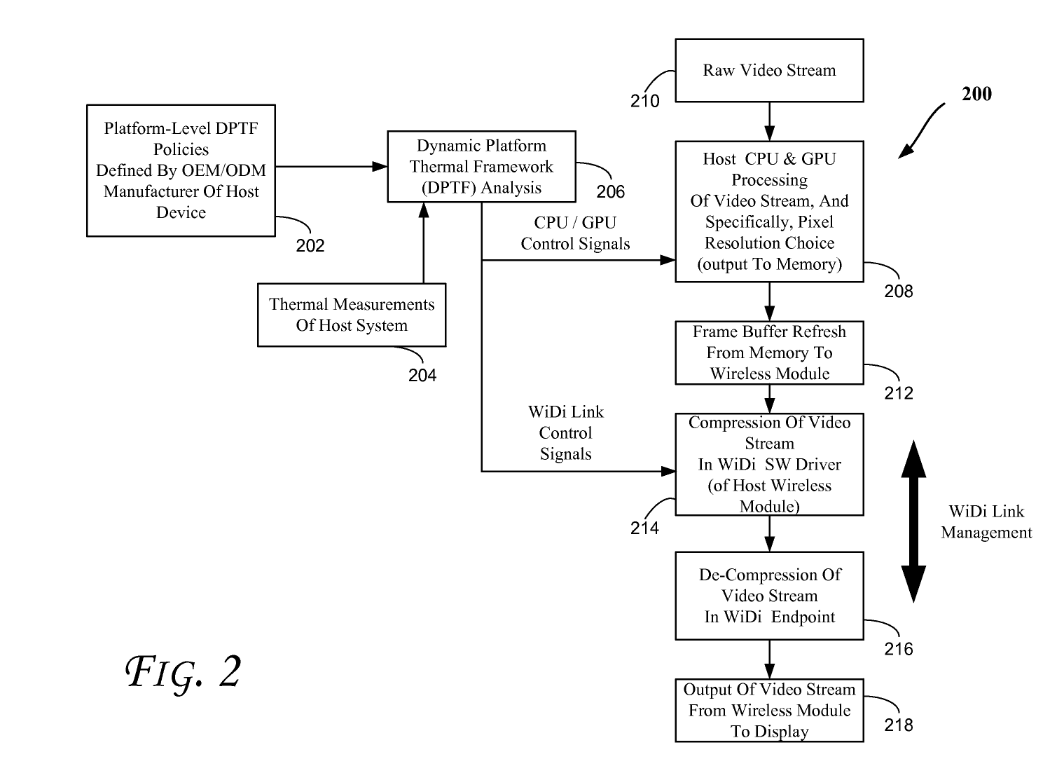

FIG. 2 illustrates a flow diagram of a method 200 to provide thermal throttling of WiDi video/image stream resolution, in accordance with an embodiment. In one embodiment, various components discussed with reference to FIGS. 1 and 3-5 may be utilized to perform one or more of the operations discussed with reference to FIG. 2. In an embodiment, one or more operations of method 200 are implemented in logic (e.g., firmware), such as logic 140, 160, 170, 190, etc. of FIG. 1.

Referring to FIGS. 1-2, platform-level DPTF (Dynamic Platform Thermal Framework) policies 202 (e.g., defined by an Original Equipment Manufacturer (OEM) or Original Design Manufacturer of a host device), as well as thermal measurements of host system components 204 (e.g., as provided by sensor(s) 150 of FIG. 1), are provided to DPTF analysis logic 206. Logic 206 can be included in logic 140 and/or 160 of FIG. 1 in some embodiments.

Logic 206 generates one or more control signals to cause the CPU/GPU (e.g., processor cores 106) and/or WiDi logic 160 (or its wireless link to the display device 180) to perform one or more operations as discussed herein. For example control signal(s) from logic 206 can be provided to the host processor (e.g., CPU and/or GPU) to process a video stream and specifically, the pixel resolution (and/or frame rate) choice to be output to memory (including memory 114 and/or other memory, and subsequently to the display 180) at operation 208, e.g., based on a raw vide stream 210. At operation 212, the frame buffer (e.g., in memory 114 or other memory) is refreshed from memory storing the video stream to the wireless logic 170.

As shown in FIG. 2, logic 206 also generates one or more control signals to control the WiDi Link that may cause a change to the compression level of the video stream (e.g., in WiDi software driver of the host wireless logic 170) at operation 214. Operation 216 decompresses the video stream received through the wireless logic 190 of display device 180 (also referred to as the WiDi endpoint). At operation 218, the decompressed video stream is output to the display 180 from the wireless logic 190.

Furthermore, while in the case of a notebook computer, the thermal budget may not impact the video/image stream much at all, in the case of a 2-in-1 platform (i.e., a tablet or Ultrabook computing device with a detachable keyboard), the thermal budget is closely related to the ability to dissipate heat, and a “rule-of-thumb” is the thermal dissipation in Watts is equal to the diagonal dimension of the display (e.g., a 13″ diagonal display can dissipate about 13 W, a 7″ display can dissipate about 7 W, and so on). When considering mobile phones and phablets, the thermal budget of a WiDi link (about 2+Watts) is a sizeable fraction of the (about 4-7 Watts) thermal budget, and in some cases would prevent the use of the WiDi link (or the background CPU/GPU processing if the link was running).

To this end, some embodiments provide a dynamically scalable video resolution, that is controlled by the available thermal headroom. And, some headroom is desirable so the platform can utilize Turbo functionality, i.e., dynamic responsiveness to a user's interaction. Accordingly, some embodiments allow a user to watch a video stream (be it at a lower resolution and/or frame rate) instead of having to watch a choppy video stream. Moreover, while changing of video/image resolution may be discussed herein, the frame rate may also be changed (alone or in conjunction with resolution). For example, the frame rate may be reduced from 60 Hz to 30 Hz with limited impact on quality, or from 30 Hz to 15 Hz which may still be viewable but slightly impaired (15 Hz would still be better than choppy video in many circumstances).

The video resolution scaling has multiple thermal impacts on the platform. Reducing the video resolution and/or frame rate:
Reduces the CPU, and especially the GPU workload, by minimizing the number of pixels that require processing;
Reduces the amount of video scaling, e.g., from 720p source to 1080p output;
Reduces the frame buffer size required to store a video frame; and/or
Reduces the frame buffer cycles required to transmit each video frame; and/or
Reduces the I/O power to transmit/receive video frame information to/from the frame buffer; and/or
Reduces the number of pixels transmitted across the wireless link, (especially when the WiDi wireless link makes no change to the video compression).

Several examples will highlight the use cases. First, in a “docked” mode, when the device is less thermally constrained, the full video BW can be transmitted (e.g., today this would be 1080p, though the content may still be 720p, and in future this may be 2K-4K video, etc.). In un-docked mode, the device is thermally constrained but the CPU/GPU workload is relatively light; hence, the video BW may be kept at the 1080p value, or the system may make policy decisions to limit the BW to 720p to prolong battery life, for example. In thermally constrained mode, for example when there is significant CPU/GPU workload, the BW may be reduced to 480p, VGA (Video Graphics Array, having 640 by 480 pixels; with a 1.33:1 aspect ratio), even QVGA (Quarter VGA, having 320 by 240 pixels; 1.33:1 aspect ratio), to meet the thermal constraints on the system.

For some platform form factors, such as mobile phones or phablets, the output resolution of the video stream may be a fixed (or maximum) resolution due to thermal limits. This may require the host scaling the video stream down (instead of up) to meet the thermal budget of the platform CPU/GPU capabilities. Hence, the video stream displayed may be subsequently scaled up at the device side, due to the monitor/LCD (Liquid Crystal Display) display resolution. This activity does not affect the thermal budget of the host system.

FIG. 3 illustrates a block diagram of a computing system 300 in accordance with an embodiment. The computing system 300 may include one or more central processing unit(s) (CPUs) 302 or processors that communicate via an interconnection network (or bus) 304. The processors 302 may include a general purpose processor, a network processor (that processes data communicated over a computer network 303), or other types of a processor (including a reduced instruction set computer (RISC) processor or a complex instruction set computer (CISC)).

Moreover, the processors 302 may have a single or multiple core design. The processors 302 with a multiple core design may integrate different types of processor cores on the same integrated circuit (IC) die. Also, the processors 302 with a multiple core design may be implemented as symmetrical or asymmetrical multiprocessors. In an embodiment, one or more of the processors 302 may be the same or similar to the processors 102 of FIG. 1. For example, one or more components of system 300 may include one or more of logic 140/160/170/190/206 and/or sensor(s) 150 discussed with reference to FIGS. 1-2. Also, the operations discussed with reference to FIGS. 1-2 may be performed by one or more components of the system 300.

A chipset 306 may also communicate with the interconnection network 304. The chipset 306 may include a graphics memory control hub (GMCH) 308, which may be located in various components of system 300 (such as those shown in FIG. 3). The GMCH 308 may include a memory controller 310 that communicates with a memory 312 (which may be the same or similar to the memory 114 of FIG. 1). The memory 312 may store data, including sequences of instructions, that may be executed by the CPU 302, or any other device included in the computing system 300. In one embodiment, the memory 312 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 304, such as multiple CPUs and/or multiple system memories.

The GMCH 308 may also include a graphics interface 314 that communicates with a display device 316 (which may be the same or similar to the display device 180 of FIG. 1). In one embodiment, the graphics interface 314 may communicate with the display device 316 via an accelerated graphics port (AGP) or Peripheral Component Interconnect (PCI) (or PCI express (PCIe) interface). In an embodiment, the display 316 (such as a flat panel display) may communicate with the graphics interface 314 through, for example, a signal converter that translates a digital representation of an image stored in a storage device such as video memory or system memory into display signals that are interpreted and displayed by the display 316. The display signals produced by the display device may pass through various control devices before being interpreted by and subsequently displayed on the display 316.

A hub interface 318 may allow the GMCH 308 and an input/output control hub (ICH) 320 to communicate. The ICH 320 may provide an interface to I/O device(s) that communicate with the computing system 300. The ICH 320 may communicate with a bus 322 through a peripheral bridge (or controller) 324, such as a peripheral component interconnect (PCI) bridge, a universal serial bus (USB) controller, or other types of peripheral bridges or controllers. The bridge 324 may provide a data path between the CPU 302 and peripheral devices. Other types of topologies may be utilized. Also, multiple buses may communicate with the ICH 320, e.g., through multiple bridges or controllers. Moreover, other peripherals in communication with the ICH 320 may include, in various embodiments, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 322 may communicate with an audio device 326, one or more disk drive(s) 328, and a network interface device 330 (which is in communication with the computer network 303, e.g., via a wired or wireless interface). As shown, the network interface device 330 may be coupled to an antenna 331 to wirelessly (e.g., via an Institute of Electrical and Electronics Engineers (IEEE) 802.11 interface (including IEEE 802.11a/b/g/n, etc.), cellular interface, 3G, 5G, LPE, etc.) communicate with the network 303, or directly with logic 190 of display device 180. Hence, logic 190 may also include an antenna (not shown) in an embodiment. Other devices may communicate via the bus 322. Also, various components (such as the network interface device 330) may communicate with the GMCH 308 in some embodiments. In addition, the processor 302 and the GMCH 308 may be combined to form a single chip. Furthermore, a graphics accelerator may be included within the GMCH 308 in other embodiments.

Furthermore, the computing system 300 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 328), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

FIG. 4 illustrates a computing system 400 that is arranged in a point-to-point (PtP) configuration, according to an embodiment. In particular, FIG. 4 shows a system where processors, memory, and input/output devices are interconnected by a number of point-to-point interfaces. The operations discussed with reference to FIGS. 1-3 may be performed by one or more components of the system 400.

As illustrated in FIG. 4, the system 400 may include several processors, of which only two, processors 402 and 404 are shown for clarity. The processors 402 and 404 may each include a local memory controller hub (MCH) 406 and 408 to enable communication with memories 410 and 412. The memories 410 and/or 412 may store various data such as those discussed with reference to the memory 312 of FIG. 3.

In an embodiment, the processors 402 and 404 may be one of the processors 302 discussed with reference to FIG. 3. The processors 402 and 404 may exchange data via a point-to-point (PtP) interface 414 using PtP interface circuits 416 and 418, respectively. Also, the processors 402 and 404 may each exchange data with a chipset 420 via individual PtP interfaces 422 and 424 using point-to-point interface circuits 426, 428, 430, and 432. The chipset 420 may further exchange data with a graphics circuit 434 via a graphics interface 436, e.g., using a PtP interface circuit 437 (e.g., where the exchanged data includes a video/image stream such as discussed with reference to FIGS. 1-3 to be displayed on a display device 180/316.

At least one embodiment may be provided within the processors 402 and 404. For example, one or more components of system 400 may include one or more of logic 140/160/170/190/206 and/or sensor(s) 150 of FIGS. 1-3, including located within the processors 402 and 404. Other embodiments, however, may exist in other circuits, logic units, or devices within the system 400 of FIG. 4. Furthermore, other embodiments may be distributed throughout several circuits, logic units, or devices illustrated in FIG. 4.

The chipset 420 may communicate with a bus 440 using a PtP interface circuit 441. The bus 440 may communicate with one or more devices, such as a bus bridge 442 and I/O devices 443. Via a bus 444, the bus bridge 442 may communicate with other devices such as a keyboard/mouse 445, communication devices 446 (such as modems, network interface devices, or other communication devices that may communicate with the computer network 303), audio I/O device 447, and/or a data storage device 448. The data storage device 448 may store code 449 that may be executed by the processors 402 and/or 404.

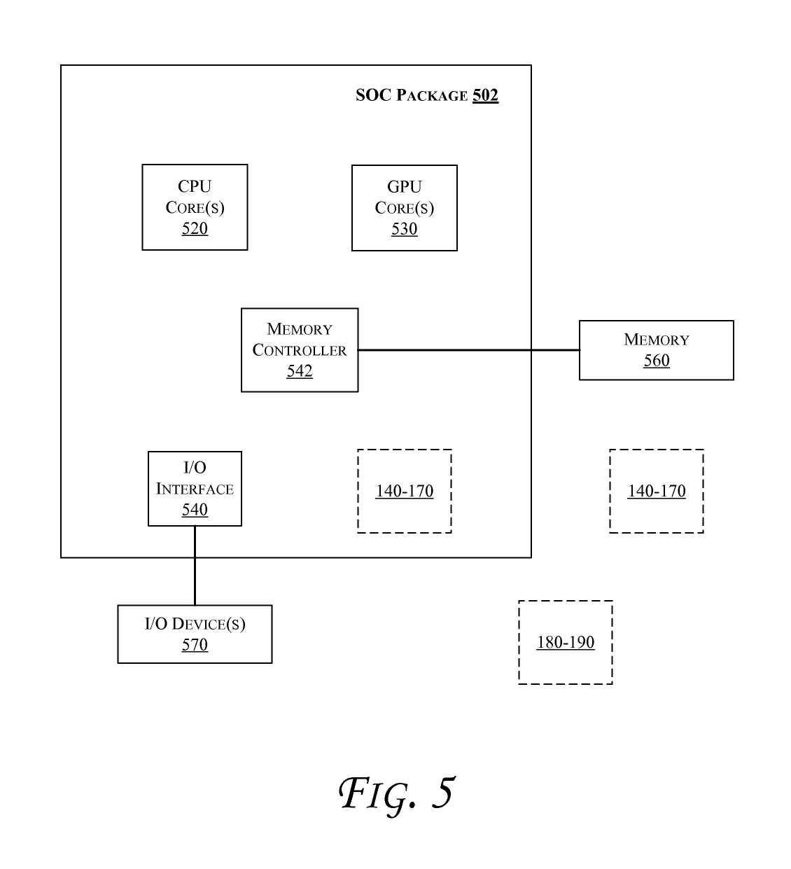

In some embodiments, one or more of the components discussed herein can be embodied as a System On Chip (SOC) device. FIG. 5 illustrates a block diagram of an SOC package in accordance with an embodiment. As illustrated in FIG. 5, SOC 502 includes one or more Central Processing Unit (CPU) cores 520, one or more Graphics Processor Unit (GPU) cores 530, an Input/Output (I/O) interface 540, and a memory controller 542. Various components of the SOC package 502 may be coupled to an interconnect or bus such as discussed herein with reference to the other figures. Also, the SOC package 502 may include more or less components, such as those discussed herein with reference to the other figures. Further, each component of the SOC package 520 may include one or more other components, e.g., as discussed with reference to the other figures herein. In one embodiment, SOC package 502 (and its components) is provided on one or more Integrated Circuit (IC) die, e.g., which are packaged into a single semiconductor device.

As illustrated in FIG. 5, SOC package 502 is coupled to a memory 560 (which may be similar to or the same as memory discussed herein with reference to the other figures) via the memory controller 542. In an embodiment, the memory 560 (or a portion of it) can be integrated on the SOC package 502.

The I/O interface 540 may be coupled to one or more I/O devices 570, e.g., via an interconnect and/or bus such as discussed herein with reference to other figures. I/O device(s) 570 may include one or more of a keyboard, a mouse, a touchpad, a display, an image/video capture device (such as a camera or camcorder/video recorder), a touch screen, a speaker, or the like. Furthermore, SOC package 502 may include/integrate one or more of the logic 140/160/170/190/206 and/or sensor(s) 150 in an embodiment. Alternatively, one or more of the logic 140/160/170/190/206 and/or sensor(s) 150 may be provided outside of the SOC package 502 (i.e., as a discrete logic).

The following examples pertain to further embodiments. Example 1 includes an apparatus comprising: first logic, the logic at least partially comprising hardware logic, to generate one or more signals to cause a processor to change at least one of a resolution or frame rate of a video stream in response to input from one or more sensors and one or more values. Example 2 includes the apparatus of example 1, wherein the one or more signals are to cause wireless display logic to modify a compression level of the video stream received from the processor prior to transmission of a compressed version of the video stream to a display device. Example 3 includes the apparatus of example 1, wherein the processor is to comprise a general-purpose processor or a graphics processor. Example 4 includes the apparatus of example 1, wherein the one or more sensors to detect variations, corresponding to components of the processor, in one or more of: temperature, operating frequency, operating voltage, operating current, dynamic capacitance, power consumption, inter-core communication activity, or docking configuration. Example 5 includes the apparatus of example 1, wherein a compression level of the video stream is to be modified in a wireless software driver for wireless logic of a computing device that includes the processor. Example 6 includes the apparatus of example 1, comprising wireless logic, coupled to the display device, to receive the compressed version of the video stream from wireless display logic. Example 7 includes the apparatus of example 1, comprising first wireless logic, coupled to the display device, to receive the compressed version of the video stream from second wireless logic coupled to wireless display logic. Example 8 includes the apparatus of example 1, wherein the first logic is to comprise a Dynamic Platform Thermal Framework (DPTF) logic. Example 9 includes the apparatus of example 1, wherein the one or more values are to be determined based on one or more platform-level policies. Example 10 includes the apparatus of example 1, wherein the processor is to comprise one or more processor cores to perform graphics or general-purpose computational operations. Example 11 includes the apparatus of example 1, wherein one or more of: the first logic, wireless display logic, a voltage regulator, or memory are on a single integrated circuit die.

Example 12 includes a method comprising: generating one or more signals to cause a processor to change at least one of a resolution or frame rate of a video stream in response to input from one or more sensors and one or more values. Example 13 includes the method of example 12, further comprising the one or more signals causing wireless display logic to modify a compression level of the video stream received from the processor prior to transmission of a compressed version of the video stream to a display device. Example 14 includes the method of example 12, further comprising the one or more sensors detecting variations, corresponding to components of the processor, in one or more of: temperature, operating frequency, operating voltage, operating current, dynamic capacitance, power consumption, inter-core communication activity, or docking configuration. Example 15 includes the method of example 12, wherein a compression level of the video stream is modified in a wireless software driver for wireless logic of a computing device that includes the processor. Example 16 includes the method of example 12, further comprising receiving the compressed version of the video stream from wireless display logic. Example 17 includes the method of example 12, further comprising receiving a compressed version of the video stream from second wireless logic coupled to wireless display logic. Example 18 includes the method of example 12, further comprising determining the one or more values based on one or more platform-level policies.

Example 19 includes a computer-readable medium comprising one or more instructions that when executed on a processor configure the processor to perform one or more operations to: generate one or more signals to cause the processor to change at least one of a resolution or frame rate of a video stream in response to input from one or more sensors and one or more values. Example 20 includes the computer-readable medium of example 19, further comprising one or more instructions that when executed on the processor configure the processor to perform one or more operations to cause the one or more signals to cause wireless display logic to modify a compression level of the video stream received from the processor prior to transmission of a compressed version of the video stream to a display device. Example 21 includes the computer-readable medium of example 19, further comprising one or more instructions that when executed on the processor configure the processor to perform one or more operations to cause the one or more sensors to detect variations, corresponding to components of the processor, in one or more of: temperature, operating frequency, operating voltage, operating current, dynamic capacitance, power consumption, inter-core communication activity, or docking configuration. Example 22 includes the computer-readable medium of example 19, further comprising one or more instructions that when executed on the processor configure the processor to perform one or more operations to cause a compression level of the video stream to be modified in a wireless software driver for wireless logic of a computing device that includes the processor. Example 23 includes the computer-readable medium of example 19, further comprising one or more instructions that when executed on the processor configure the processor to perform one or more operations to cause receipt of the compressed version of the video stream from wireless display logic. Example 24 includes the computer-readable medium of example 19, further comprising one or more instructions that when executed on the processor configure the processor to perform one or more operations to cause receipt of a compressed version of the video stream from second wireless logic coupled to wireless display logic. Example 25 includes the computer-readable medium of example 19, further comprising one or more instructions that when executed on the processor configure the processor to perform one or more operations to cause determination of the one or more values based on one or more platform-level policies.

Example 26 includes a system comprising: a processor having one or more processor cores; memory to store data, corresponding to at least one frame of a scene, to be accessed by at least one of the one or more processor cores; a display device to present the at least one frame of the scene; first logic, the logic at least partially comprising hardware logic, to generate one or more signals to cause the processor to change at least one of a resolution or frame rate of a video stream in response to input from one or more sensors and one or more values. Example 27 includes the system of example 26, wherein the one or more signals are to cause wireless display logic to modify a compression level of the video stream received from the processor prior to transmission of a compressed version of the video stream to the display device. Example 28 includes the system of example 26, wherein the processor is to comprise a general-purpose processor or a graphics processor. Example 29 includes the system of example 26, wherein the one or more sensors to detect variations, corresponding to components of the processor, in one or more of: temperature, operating frequency, operating voltage, operating current, dynamic capacitance, power consumption, inter-core communication activity, or docking configuration. Example 30 includes the system of example 26, wherein a compression level of the video stream is to be modified in a wireless software driver for wireless logic of a computing device that includes the processor. Example 31 includes the system of example 26, comprising wireless logic, coupled to the display device, to receive the compressed version of the video stream from wireless display logic. Example 32 includes the system of example 26, comprising first wireless logic, coupled to the display device, to receive the compressed version of the video stream from second wireless logic coupled to wireless display logic. Example 33 includes the system of example 26, wherein the first logic is to comprise a Dynamic Platform Thermal Framework (DPTF) logic. Example 34 includes the system of example 26, wherein the one or more values are to be determined based on one or more platform-level policies. Example 35 includes the system of example 26, wherein the processor is to comprise one or more processor cores to perform graphics or general-purpose computational operations. Example 36 includes the system of example 26, wherein one or more of: the first logic, the wireless display logic, a voltage regulator, or the memory are on a single integrated circuit die.

Example 37 includes an apparatus comprising means to perform a method as set forth in any preceding example. Example 38 includes machine-readable storage including machine-readable instructions, when executed, to implement a method or realize an apparatus as set forth in any preceding example.

Example In various embodiments, the operations discussed herein, e.g., with reference to FIGS. 1-5, may be implemented as hardware (e.g., logic circuitry), software, firmware, or combinations thereof, which may be provided as a computer program product, e.g., including a tangible (e.g., non-transitory) machine-readable or computer-readable medium having stored thereon instructions (or software procedures) used to program a computer to perform a process discussed herein. The machine-readable medium may include a storage device such as those discussed with respect to FIGS. 1-5.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
first logic, the logic at least partially comprising hardware logic, to generate one or more signals to cause a processor to change at least one of a resolution or frame rate of a video stream in response to input from one or more sensors and one or more values.

2. The apparatus of claim 1, wherein the one or more signals are to cause wireless display logic to modify a compression level of the video stream received from the processor prior to transmission of a compressed version of the video stream to a display device.

3. The apparatus of claim 1, wherein the processor is to comprise a general-purpose processor or a graphics processor.

4. The apparatus of claim 1, wherein the one or more sensors to detect variations, corresponding to components of the processor, in one or more of: temperature, operating frequency, operating voltage, operating current, dynamic capacitance, power consumption, inter-core communication activity, or docking configuration.

5. The apparatus of claim 1, wherein a compression level of the video stream is to be modified in a wireless software driver for wireless logic of a computing device that includes the processor.

6. The apparatus of claim 1, comprising wireless logic, coupled to the display device, to receive the compressed version of the video stream from wireless display logic.

7. The apparatus of claim 1, comprising first wireless logic, coupled to the display device, to receive the compressed version of the video stream from second wireless logic coupled to wireless display logic.

8. The apparatus of claim 1, wherein the first logic is to comprise a Dynamic Platform Thermal Framework (DPTF) logic.

9. The apparatus of claim 1, wherein the one or more values are to be determined based on one or more platform-level policies.

10. The apparatus of claim 1, wherein the processor is to comprise one or more processor cores to perform graphics or general-purpose computational operations.

11. The apparatus of claim 1, wherein one or more of: the first logic, wireless display logic, a voltage regulator, or memory are on a single integrated circuit die.

12. A method comprising:
generating one or more signals to cause a processor to change at least one of a resolution or frame rate of a video stream in response to input from one or more sensors and one or more values.

13. The method of claim 12, further comprising the one or more signals causing wireless display logic to modify a compression level of the video stream received from the processor prior to transmission of a compressed version of the video stream to a display device.

14. The method of claim 12, further comprising the one or more sensors detecting variations, corresponding to components of the processor, in one or more of: temperature, operating frequency, operating voltage, operating current, dynamic capacitance, power consumption, inter-core communication activity, or docking configuration.

15. The method of claim 12, wherein a compression level of the video stream is modified in a wireless software driver for wireless logic of a computing device that includes the processor.

16. A computer-readable medium comprising one or more instructions that when executed on a processor configure the processor to perform one or more operations to:
generate one or more signals to cause the processor to change at least one of a resolution or frame rate of a video stream in response to input from one or more sensors and one or more values.

17. The computer-readable medium of claim 16, further comprising one or more instructions that when executed on the processor configure the processor to perform one or more operations to cause the one or more signals to cause wireless display logic to modify a compression level of the video stream received from the processor prior to transmission of a compressed version of the video stream to a display device.

18. The computer-readable medium of claim 16, further comprising one or more instructions that when executed on the processor configure the processor to perform one or more operations to cause the one or more sensors to detect variations, corresponding to components of the processor, in one or more of: temperature, operating frequency, operating voltage, operating current, dynamic capacitance, power consumption, inter-core communication activity, or docking configuration.

19. The computer-readable medium of claim 16, further comprising one or more instructions that when executed on the processor configure the processor to perform one or more operations to cause a compression level of the video stream to be modified in a wireless software driver for wireless logic of a computing device that includes the processor.

20. The computer-readable medium of claim 16, further comprising one or more instructions that when executed on the processor configure the processor to perform one or more operations to cause receipt of the compressed version of the video stream from wireless display logic.

21. The computer-readable medium of claim 16, further comprising one or more instructions that when executed on the processor configure the processor to perform one or more operations to cause receipt of a compressed version of the video stream from second wireless logic coupled to wireless display logic.

22. The computer-readable medium of claim 16, further comprising one or more instructions that when executed on the processor configure the processor to perform one or more operations to cause determination of the one or more values based on one or more platform-level policies.

23. A system comprising:
a processor having one or more processor cores;
memory to store data, corresponding to at least one frame of a scene, to be accessed by at least one of the one or more processor cores;
a display device to present the at least one frame of the scene;
first logic, the logic at least partially comprising hardware logic, to generate one or more signals to cause the processor to change at least one of a resolution or frame rate of a video stream in response to input from one or more sensors and one or more values.

24. The system of claim 23, wherein the one or more signals are to cause wireless display logic to modify a compression level of the video stream received from the processor prior to transmission of a compressed version of the video stream to the display device.

25. The system of claim 23, wherein the processor is to comprise a general-purpose processor or a graphics processor.
